(19) United States
(12) Patent Application Publication
(10) Pub. No.: US 2020/0231005 A1
(43) Pub. Date: Jul. 23, 2020

(54) STEEL CORD AND TIRE

(71) Applicant: SUMITOMO ELECTRIC TOCHIGI CO., LTD., Tochigi (JP)

(72) Inventors: Akifumi MATSUOKA, Tochigi (JP); Yoshiaki OKABAYASHI, Tochigi (JP); Kazuhiko SAITO, Tochigi (JP)

(21) Appl. No.: 16/650,571

(22) PCT Filed: Aug. 10, 2018
(86) PCT No.: PCT/JP2018/030114

§ 371 Date: Mar. 25, 2020

(30) Foreign Application Priority Data
Oct. 6, 2017 (JP) 2017-196349

(51) Int. Cl. B60C 9/00; B60C 9/02; D07B 1/06

(52) U.S. Cl. CPC B60C 9/0007; B60C 9/0057; D07B 2201/2023; D07B 1/0606; D07B 2501/2046; B60C 9/023

(57) ABSTRACT

A steel cord includes a two-layer stranded construction including a core in which two or three core filaments are twisted, and including a one-layer outer sheath in which outer sheath filaments are helically wound around the core and along a longitudinal direction of the core. The core filaments have same filament diameters as the outer sheath filaments, length of lay for the core is same as length of lay for the outer sheath, and length of lay/filament diameter, which indicates a ratio of length of lay to a filament diameter, is between 50 and 75. Two or more filaments selected from among the core filaments and the outer sheath filaments, are crimped filaments each including bent sections and non-bent sections that are repeatedly disposed along the longitudinal direction.

### TECHNICAL FIELD

The present invention relates to a steel cord and a tire.

The present application claims priority to Japanese Patent Application No. 2017-196349, filed Oct. 6, 2017, the contents of which are incorporated herein by reference in their entirety.

### BACKGROUND ART

Patent document 1 proposes a steel cord embedded in a rubber formed body in order to reinforce the rubber formed body, the steel cord including two core wires; and five side wires having diameters larger than the core wires, the five side wires being twisted together with the core wires and around the core wires, and wherein a cross-section of strands composed of the five side wires and the two core wires is flat.

### CITATION LIST

### Patent Document

[Patent Document 1] Japanese Unexamined Patent Application Publication No. H9-31876

### SUMMARY OF INVENTION

According to one aspect of the present disclosure, a steel cord includes:

a two-layer stranded construction including a core in which two or three core filaments are twisted, and including a one-layer outer sheath in which outer sheath filaments are helically wound around the core and along a longitudinal direction of the core,

wherein the core filaments have same filament diameters as the outer sheath filaments,

wherein length of lay for the core is same as length of lay for the outer sheath,

wherein length of lay/filament diameter, which indicates a ratio of length of lay to a filament diameter, is between 50 and 75, and

wherein two or more filaments selected from among the core filaments and the outer sheath filaments, are crimped filaments each including bent sections and non-bent sections that are repeatedly disposed along the longitudinal direction.

### BRIEF DESCRIPTION OF DRAWINGS

FIG. 1 is a diagram for explaining a steel cord having a 2+7 construction according to one aspect of the present disclosure;

FIG. 2 is a cross-sectional view taken along a plane perpendicular to a longitudinal direction of the steel cord of FIG. 1;

FIG. 3 is a cross-sectional view taken along a plane perpendicular to a longitudinal direction of a 3+8 construction according to one aspect of the present disclosure;

FIG. 4 is a diagram for explaining a crimped filament in which bent sections and non-bent sections are repeatedly formed;

FIG. 5 is a diagram for explaining a method for manufacturing a crimped filament in which bent sections and non-bent sections are repeatedly formed;

FIG. 6 is a cross-sectional view of a tire according to one aspect of the present disclosure; and

FIG. 7 is a diagram schematically illustrating belt layers.

### DESCRIPTION OF EMBODIMENTS

### Problems to be Solved by the Present Disclosure

However, with respect to the steel cord disclosed in Patent document 1, because core wires differ from side wires in diameter, different types of filaments are required to be prepared and thus there is a problem in increased costs, reduced productivity, or the like.

Additionally, if core filaments and outer sheath filaments each of which has the same filament diameter are used, rubber penetration may be reduced when such steel cords are placed within a tire.

In light of the point described above, an objective of the present disclosure is to provide a steel cord including a two-layer stranded construction in which length of lay for a core is the same as that for an outer sheath, and in which core filaments have the same filament diameters as outer sheath filaments, as well as having excellent rubber penetration.

### Effect of Present Disclosure

According to the present disclosure, a steel cord can be provided including a two-layer stranded construction in which length of lay for a core is the same as that for an outer sheath, and in which core filaments have the same filament diameters as outer sheath filaments, as well as having excellent rubber penetration.

### Description of Embodiments of the Present Disclosure

First, embodiments of the present disclosure will be described by listing. In the following description, the same numbers are used to denote same or corresponding elements; accordingly, explanation for those elements will not be repeatedly provided.

(1) A steel cord according to one aspect of the present disclosure includes;

a two-layer stranded construction including a core in which two or three core filaments are twisted, and including a one-layer outer sheath in which outer sheath filaments are helically wound around the core and along a longitudinal direction of the core,

wherein the core filaments have same filament diameters as the outer sheath filaments,

wherein length of lay for the core is same as length of lay for the outer sheath,

wherein length of lay/filament diameter, which indicates a ratio of length of lay to a filament diameter, is between 50 and 75, and

wherein two or more filaments selected from among the core filaments and the outer sheath filaments, are crimped filaments each including bent sections and non-bent sections that are repeatedly disposed along the longitudinal direction.

It is conventionally considered that, in a case where length of lay for a core is the same as that for an outer sheath; and core filaments have the same filament diameters as outer sheath filaments, an obtained steel cord having a two-layer stranded construction causes low rubber penetration.

This is because gaps can not be sufficiently formed between outer sheath filaments, which may result in difficulty in rubber penetrating inward.

After consideration by the inventors of the present invention, gaps are considered to be able to be sufficiently formed between outer sheath filaments, when length of lay/filament diameter is in a predetermined range; and two or more filaments selected from among core filaments and outer sheath filaments are crimped filaments.

Thus, according to a steel cord according to one aspect of the present disclosure, it is possible to provide a steel cord including a two-layer stranded construction in which length of lay for a core is the same as that for an outer sheath, and in which the core filaments have the same filament diameters as outer sheath filaments, as well as having excellent rubber penetration.

Note that in calculating length of lay/filament diameter, length of lay and a filament diameter are expressed in the same unit. For example, mm can be used.

(2) When a height from a plane on which the crimped filaments are disposed, to a far bent section away from the plane, is defined as a bend height, the bend height of each crimped filament may correspond to between 260% and 280% a bend height of a filament diameter of the crimped filament.

(3) The outer sheath filaments may include the crimped filaments.

(4) A percentage of the crimped filaments relative to the outer sheath filaments may be between 25% and 100%.

(5) The core filaments may be two core filaments.

(6) The core filaments are two core filaments, and the outer sheath filaments may be 6 to 8 outer sheath filaments.

(7) The core filaments are three core filaments, and the outer sheath filaments may be 7 to 9 outer sheath filaments.

(8) The core filaments and the outer sheath filaments each may have a filament diameter of from 0.30 mm to 0.42 mm.

(9) A tire can include steel cords according to any one of (1) to (8).

### Details of Embodiments of the Present Disclosure

Specific examples of a steel cord and a tire according to one embodiment (hereinafter referred to as “the present embodiment”) of the present disclosure will be described below with reference to the drawings. Note that the present invention is not limited to these examples, is set forth in the claims, and is intended to include all modifications implementing the equivalent to the claims and made within a scope of the claims.

<Steel Cord>

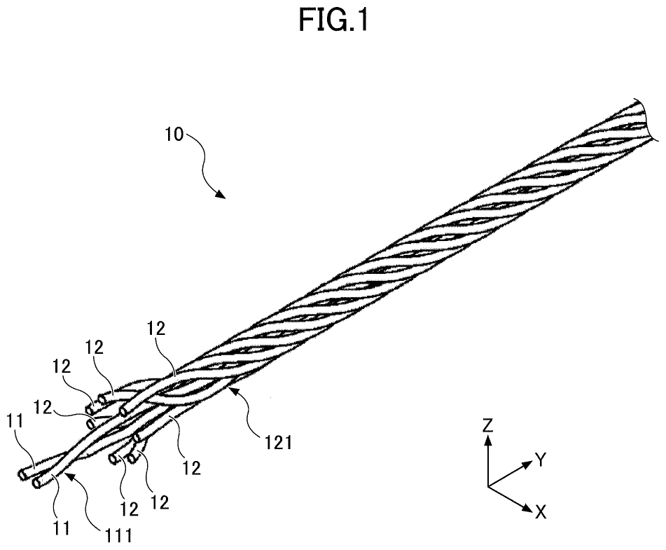

Hereafter, a given steel cord according to the present embodiment will be described with reference to FIGS. 1 to 5.

The steel cord according to the present embodiment has a two-layer stranded construction that includes a core in which core filaments are twisted; and a one-layer outer sheath in which outer sheath filaments are helically wound around the core and along a longitudinal direction of the core.

Note that in the following, when core filaments and outer sheath filaments are collectively referred to, they may be also simply referred to as filaments.

FIG. 1 illustrates an example of a construction of a steel cord 10 according to the present embodiment. With respect to the steel cord 10 illustrated in FIG. 1, a core 111 is formed by two core filaments 11 being twisted. Further, a one-layer outer sheath 121 is formed by seven outer sheath filaments 12 being helically wound around the core 111 and along a longitudinal direction of the core 111. Note that one layer means a structure in which filaments are arranged along a circumferential direction of a single circle so as to form a single layer (one layer).

A steel cord having a two-layer stranded construction with such a core and an outer sheath is expressed by an n+m construction with a number n of core filaments and a number m of outer sheath filaments. The steel cord illustrated in FIG. 1 is expressed by a 2+7 construction.

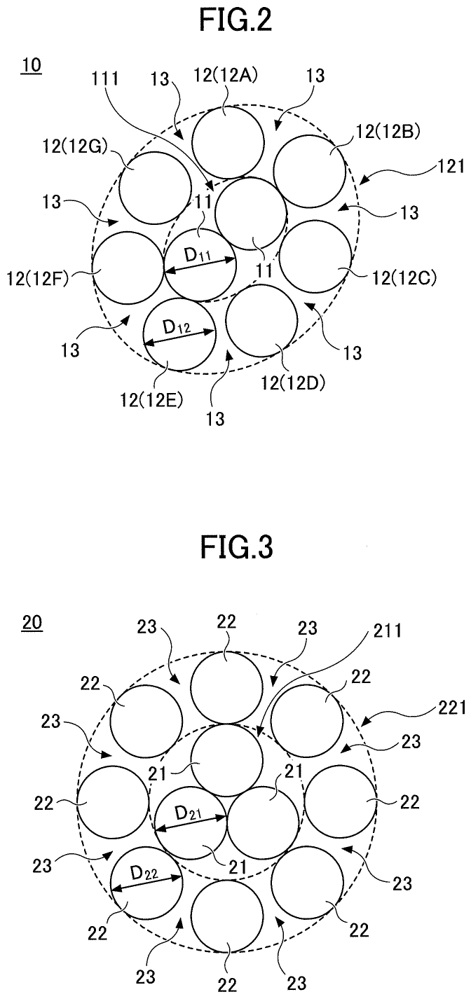

FIG. 2 is a cross-sectional view taken along a plane perpendicular to a longitudinal direction of the steel cord 10 as illustrated in FIG. 1. Note that the longitudinal direction of the steel cord 10 refers to a Y-axis direction in FIG. 1. Additionally, the plane perpendicular to the longitudinal direction refers to a plane parallel to an XZ plane in FIG. 1.

As illustrated in FIG. 2, with respect to the steel cord 10, a core 111 is formed by two core filaments 11 being twisted. Further, a one-layer outer sheath 121 is formed by seven outer sheath filaments 12 being twisted so as to surround the core 111. Note that gaps 13 can be formed between outer sheath filaments 12, and by adjusting a width of each gap 13, rubber penetration, which means that rubber is easily penetrated into a steel cord in vulcanizing the rubber, can be increased.

The core filaments in a steel cord according to the present embodiment can be two or three core filaments.

FIG. 3 is a cross-sectional view taken along a plane perpendicular to a longitudinal direction of a steel cord 20 that has a 3+8 construction with three core filaments.

With respect to the steel cord 20 having the 3+8 construction as illustrated in FIG. 3, a core 211 is formed by three core filaments 21 being twisted. Further, an outer sheath 221 is formed by eight outer sheath filaments 22 being twisted so as to surround the core 211.

Note that the outer sheath filaments 22 are helically wound along a longitudinal direction of the core 211, so that the outer sheath 221 is formed. Further, gaps 23 can be formed between outer sheath filaments 22.

In this description, two examples of constructions are illustrated. However, the number of outer sheath filaments 12 or 22 is not limited to the configurations described above.

For example, when two core filaments are used, it is preferable that the number of outer sheath filaments be between 6 and 8. This is because, when the number of core filaments is 2, in a case of the number of outer sheath filaments being 6 or more, gaps between outer sheath filaments are prevented from being excessively large, so that flare generation can be thereby suppressed. Note that flare refers to a phenomenon of strands of filaments untwisting and spreading in a case of a steel cord being cut.

Further, it is because, when two core filaments are used, in a case of the number of outer sheath filaments being 8 or less, sufficient gaps between outer sheath filaments are secured, so that a performance for filling rubber can be particularly increased.

When two core filaments are used, more preferably, the number of outer sheath filaments is 7.

When three core filaments are used, it is preferable that the number of outer sheath filaments be between 7 and 9. This is because when the number of core filaments is 3, in a case of the number of outer sheath filaments being 7 or more, gaps between outer sheath filaments are prevented from being excessively large, so that flare generation can be thereby suppressed. Additionally, it is because, when the number of core filaments is 3, in a case of the number of outer sheath filaments being 9 or less, sufficient gaps between outer sheath filaments are secured, so that a performance for filling rubber can be particularly increased.

When three core filaments are used, more preferably, the number of outer sheath filaments is 8.

As described above, with respect to a given steel cord according to the present embodiment, the number of core filaments can be 2 or 3. In particular, it is preferred that two core filaments be used. In this regard, when two core filaments are used, the steel cord as illustrated in FIG. 2 can have a flat shape in a cross section perpendicular to a longitudinal direction of the steel cord. For this reason, a cross-sectional area of the steel cord can be reduced, and when such a steel cord is used for a tire, the tire can become compact. Thereby, rubber usage can be suppressed, and design for weight reduction is enabled.

Further, with respect to a given steel cord according to the present embodiment, core filaments have filament diameters (wire diameters) that are the same as those (wire diameters) of outer sheath filaments. In other words, in the example of FIG. 2, a diameter D₁₁ indicating a diameter of each core filament 11 is the same as a diameter D₁₂ indicating a diameter of each outer sheath filament 12. Further, in the example of FIG. 3, a diameter D₂₁ indicating a diameter of each core filament 21 is the same as a diameter D₂₂ indicating a filament diameter of each outer sheath filament 22.

As described above, with core filaments having the same filament diameters as outer sheath filaments, the same filaments can be used as the core filaments and the outer sheath filaments. Thus, in manufacturing steel cords, types of filaments to be prepared can be reduced, thereby allowing for reductions in costs, as well as being able to increase productivity.

Note that filament diameters of core filaments and filament diameters of outer sheath filaments each have a certain manufacturing tolerance. Accordingly, in a case of being within a range of tolerances, the same diameter can be used.

For example, when a relation between a filament diameter d_{c} of a given core filament and a filament diameter dₛ of a given outer sheath filament is given by 0.92≤d_{c}/dₛ≤1.08, the diameters can be regarded as being within the range of tolerances. Thus, in this case, the filament diameter d_{c} of a given core filament can be the same diameter as the filament diameter dₛ of a given outer sheath filament.

Further, with respect to a given steel cord according to the present embodiment, length of lay for the core can be the same as that for the outer sheath.

When length of lay for a core is the same as that for an outer sheath, for example, manufacturing can be achieved by core filaments and outer sheath filaments being twisted together. Thereby, productivity can be increased, which is advantageous.

However, it is conventionally considered that an obtained steel cord having a two-layer stranded construction causes low rubber penetration, when length of lay for a core is the same as that for an outer sheath; and core filaments have the same filament diameters as outer sheath filaments.

This is because there were cases of gaps not being sufficiently formed between outer sheath filaments, resulting in difficulty in rubber penetrating inward.

In light of the point described above, after consideration by the inventors of the present invention, it is preferable that length of lay/filament diameter, which indicates a ratio of length of lay (mm) for each of a core and an outer sheath, to a filament diameter (mm) for each of core filaments and outer sheath filaments, be between 50 and 75. It is considered by the inventors of the present invention that, this is because, when length of lay/filament diameter is 75 or less, gaps can be sufficiently formed between outer sheath filaments, so that rubber penetration can be sufficiently increased.

As described above, rubber penetration means that rubber is easily penetrated into a steel cord in vulcanizing the rubber. In general, a steel cord is used as a member for reinforcing a tire and is placed in rubber of a tire. In such a manner, adhesion to a tire is increased as rubber penetration increases, and durability of the tire can be increased accordingly.

Further, when length of lay/filament diameter is 75 or less, length of lay can be sufficiently reduced, and thus outer sheath filaments can be easily wound. Thereby, generation of flare, which refers to a phenomenon of strands of filaments untwisting and spreading in a case of a steel cord being cut, can be suppressed.

For example, when a steel cord using filaments of same diameter is manufactured, a rotation speed at which a wire drawing machine operates can be increased as length of lay increases, and thus a manufacturing speed is increased. For this reason, when length of lay/filament diameter is 50 or more, productivity can be increased, which is advantageous.

In order to increase productivity, length of lay/filament diameter is preferably between 65 and 74, and more preferably between 70 and 74.

With respect to a given steel cord according to the present embodiment, preferably, two or more filaments selected from among core filaments and outer sheath filaments are crimped filaments each including bent sections and non-bent sections that are repeatedly disposed along a longitudinal direction.

In such a manner, when two or more filaments selected from core filaments and outer sheath filaments are crimped filaments, rubber penetration is considered to be able to increase, with being synergistically influenced by the above length of lay/filament diameter that is in a predetermined range.

Hereafter, a crimped filament will be described.

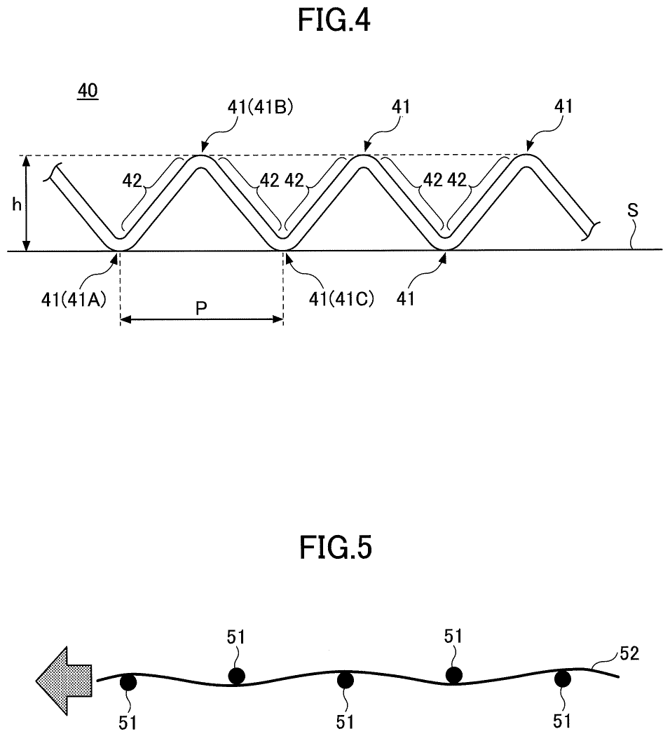

FIG. 4 is a diagram illustrating an example of a crimped filament 40. The crimped filament 40 includes bent sections 41 and non-bent sections 42 that are alternatingly repeatedly disposed along a longitudinal direction.

When two or more filaments selected from core filaments and outer sheath filaments are crimped filaments 40 each including bent sections 41 and non-bent sections 42 that are alternatingly repeatedly disposed, for example, gaps between outer sheath filaments can be increased. Accordingly, rubber penetration can be increased, which is advantageous.

Note that in FIG. 4, an example in which each bent section 41 is bent at an angle of approximately 90 degrees is illustrated. However, each bent section is not limited to such a configuration, and each bent section may be bent at an angle of smaller than 90 degrees or larger than 90 degrees, for example.

As illustrated in an example FIG. 5, assuming that multiple gears 51 are disposed, a crimped filament can be formed by a filament 52 being interposed by the gears 51. The shape of bent sections, length of non-bent sections, or the like can be selected in accordance with arrangement, sizes, or the like of the gears 51 being varied.

With respect to the steel cords according to the present embodiment, it is preferable that given outer sheath filaments include crimped filaments, from the viewpoint of rubber penetration being increased particularly. Note that a construction in which only outer sheath filaments include crimped filaments can also be taken.

With sufficient gaps being formed between outer sheath filaments, rubber penetration in a steel cord can be increased. Further, when given outer sheath filaments include crimped filaments, gaps between outer sheath filaments can be particularly increased. Thereby, rubber penetration in a steel cord can be increased, which is advantageous.

Particularly, a percentage of the number of crimped outer sheath filaments relative to outer sheath filaments is preferably between 25% and 100%, and more preferably between 50% and 90%. Note that in an example in which the number of outer sheath filaments is 7, for example, it is meant that the number of crimped filaments from among seven outer sheath filaments is preferably between 2 and 7, and more preferably between 4 and 6.

This is because, when the number of crimped filaments from among outer sheath filaments corresponds to 25% or more the number of the outer sheath filaments, gaps between outer sheath filaments are particularly increased so that rubber penetration can be increased. Further, all outer sheath filaments can be crimped filaments. The number of crimped filaments from among outer sheath filaments can correspond to 100% or less.

A specific crimped shape of a given crimped filament is not particularly restricted. However, it is preferable that a bend height h of a given crimped filament correspond to between 260% and 280% of a filament diameter of the crimped filament.

Now, as illustrated in FIG. 4, when a crimped filament 40 is placed on a plane S, a height from the plane S to a far bent section 41B away from the plane S, is defined as a bend height h.

When the bend height h corresponds to 260% or more of a given filament diameter, a crimped filament has a sufficient bend height, compared to the filament diameter. In other words, gaps can be sufficiently formed between a given crimped filament and another filament. Thus, rubber penetration can be increased, which is advantageous.

Further, when the bend height h corresponds to 280% or less a given filament diameter, flare generation can be avoided more reliably, which is advantageous.

More preferably, a bend height h of a given crimped filament corresponds to between 265% and 280% of a given filament diameter.

With respect to a given crimped filament, pitch in which bent sections and non-bent sections are repeatedly disposed is not particularly restricted, but is preferably between 5.0 mm and 30.0 mm, and more preferably between 5.0 mm and 20.0 mm.

Pitch in which bent sections and non-bent sections are repeatedly disposed indicates a distance between bent sections each of which has the same shape, and means a length of a steel cord in a longitudinal direction, the length being from a reference bent section to a bent section that is the second from the reference bent section. In such a manner, in the example of FIG. 4, pitch P in which bent sections and non-bent sections are repeatedly disposed indicates a distance from, e.g., a bent section 41A to a bent section 41C that is second from the bent section 41A.

When pitch in which bent sections and non-bent sections are repeatedly disposed is 5.0 mm or more, the bent sections and the non-bent sections are easily formed in a given filament, and thus accurate control is easily performed, which is advantageous. Further, when pitch in which bent sections and non-bent sections are repeatedly disposed is 30.0 mm or less, the bent sections and the non-bent sections are manufactured by a relatively simple machine. Thereby, a manufacturing cost can be suppressed, which is advantageous.

A filament diameter of each of core filaments and outer sheath filaments included in a steel cord according to the present embodiment, i.e., a diameter of each filament is preferably between 0.30 mm and 0.42 mm, and more preferably between 0.35 mm and 0.41 mm.

When the filament diameter is 0.30 mm or more, in a case of steel cords with such filaments being used for a tire, durability with respect to a shock can be sufficiently increased, which is advantageous.

Further, when the filament diameter is 0.42 mm or less, in a case of steel cords with such filaments being used for a tire, a shock is sufficiently absorbed. Thereby, a comfortable ride can be increased during driving, which is advantageous.

Note that as described above, core filaments and outer sheath filaments can have the same filament diameters.

<Tire>

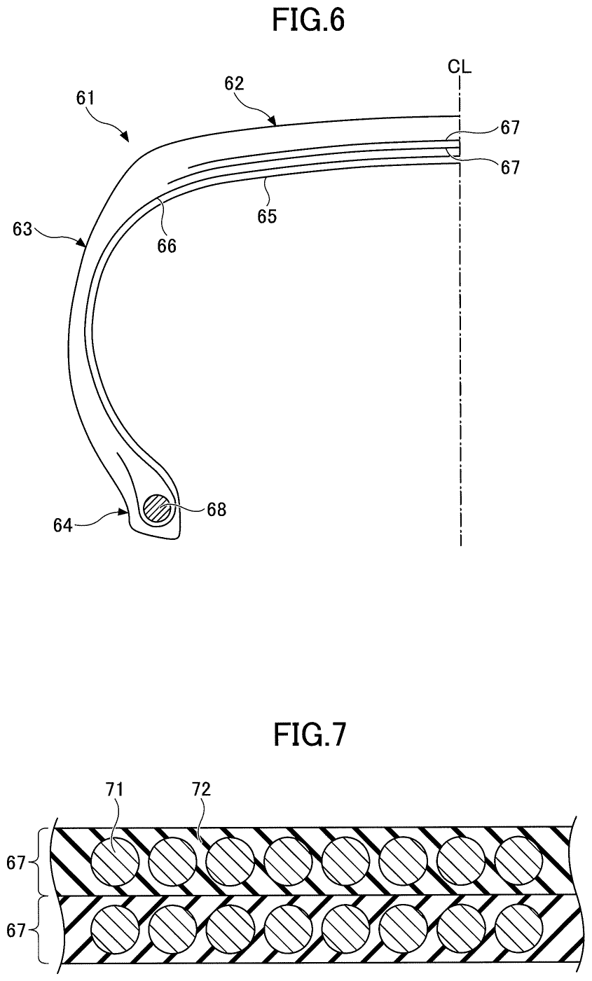

Hereafter, a tire according to the present embodiment will be described with reference to FIGS. 6 and 7.

In the present embodiment, the tire can include steel cords as described above.

FIG. 6 is a cross-sectional view taken along a plane perpendicular to a circumferential direction of a tire 61 according to the present embodiment. In FIG. 6, a left side portion of the CL (centerline) is only illustrated. However, on a right side of the CL as well, a similar structure is continuously included, where the CL is used as an axis of symmetry.

As illustrated in FIG. 6, the tire 61 includes a tread 62, a sidewall 63, and a bead 64.

The tread 62 is a portion of contact with a road surface. The bead 64 is provided toward the inside of the tire 61 with respect to the tread. 62. The bead 64 is a portion of contact with a rim of a vehicle wheel. The sidewall 63 couples the tread 62 and the bead 64. When the tread 62 is impacted through a road surface, the sidewall 63 is resiliently deformed to absorb the impact.

The tire 61 includes an inner liner 65; a carcass 66; belt layers 67; and a bead wire 68.

The inner liner 65 is formed of rubber, and seals a gap between the tire 61 and the wheel.

The carcass 66 forms a backbone of the tire 61. The carcass 66 is formed of an organic fiber, such as polyester, nylon, or rayon; and rubber.

The bead wire 68 is provided in the bead 64. The bead wire 68 receives a tensile force acting on the carcass.

The belt layers 67 tighten the carcass 66 to increase rigidity of the tread 62. In the example of FIG. 6, the tire 61 has the respective belt layers 67 with two layers.

FIG. 7 is a diagram schematically illustrating respective belt layers 67 with two layers. FIG. 7 is a cross-sectional view of the belt layers 67 in a longitudinal direction, e.g., in a plane perpendicular to a circumferential direction of the tire 61.

As illustrated in FIG. 7, the belt layers 67 with the two layers are added in a radial direction of the tire 61. Each belt layer 67 has a plurality of steel cords 71 and rubber 72. The plurality of steel cords 71 are aligned and in parallel. The rubber 72 also coats the steel cords 71, and the outer periphery of each steel cord is fully surrounded by the rubber 72. The steel cords 71 are embedded in the rubber 72.

According to the tire in the present embodiment, as the steel cords 71, steel cords with excellent rubber penetration as described above, are included. Thereby, the tire according to the present embodiment can be a tire with high adhesion of steel cords to rubber, as well as of excellent durability.

The embodiments have been described in detail above, but are not limited to a specific embodiment. Various modifications and changes can be made within a scope set forth in the claims.

### EXAMPLES

Specific examples will be explained below. However, the present invention is not limited to these examples.

### (Evaluation Method)

First, a method of evaluating steel cords produced in the following examples will be explained.

### (1) Length of Lay

Measurement was performed by a tracing method according to JIS G 3510 (1992). Specifically, first, a traceably thin paper was placed in the outer periphery of a produced steel cord, and was scraped with a pencil that is over the paper, so that a trace of strands of outer sheath filaments was copied. Then, a length of 5 pitches was measured using a ruler, based on an obtained trace of the strands of the outer sheath filaments. Then, a value divided by 5 was set as length of lay.

### (2) Flare

Evaluation was performed according to JIS G 3510 (1992). Specifically, a portion of a manufactured steel cord was fixed, and at a point that is 50 mm or more away from a fixed point, cutting was achieved by a cutter that was touched perpendicularly to a central axis of a steel cord. When a length of a cut end being scattered was 10 mm or less, evaluation was rated as A indicating that a flare did not occur. In contrast, when a length of a cut end being scattered was greater than 10 mm, evaluation was rated as B indicating that a flare occurred.

### (3) Degree of Rubber Penetration

First, manufactured steel cords were arranged at regular intervals. Specifically, manufactured steel cords were arranged on a tire rubber sheet, such that a distance between steel cords was twice a diameter of each steel cord; subsequently, the rubber sheet was overlaid. In such a manner, a laminate of the rubber sheet having a rectangular shape; and the steel cords was prepared, the laminate having a total thickness that is five times a diameter of the steel cord. The laminate of the rubber sheet and the steel cords was vulcanized under a condition at a temperature of 160° C. and for 18 minutes.

After natural cooling, a given steel cord was retrieved from an obtained steel cord/rubber complex, with a cutter knife.

Then, from a retrieved steel cord, two adjacent outer sheath filaments were removed. A percentage of a length of a portion being coated with rubber and along a center line in a region exposed by removing the two adjacent outer sheath filaments, relative to an observation length of 100 mm, was calculated, and this was taken as a degree of rubber penetration.

The degree of rubber penetration is meant to be further excellent as a value of rubber penetration is increased. When the degree of rubber penetration indicates 60% or more, a sufficient performance is meant to be provided in practice.

### TEST EXAMPLES

Steel cords in examples below were formed, and evaluation was performed as described above.

Note that in the following examples, with respect to each steel cord, a buncher drawing machine was used to: arrange core filaments and outer sheath filaments each of which has a filament diameter of 0.37 mm, in predetermined positions; and form a given steel cord by twisting them together. In such a manner, length of lay for a core in which the core filaments were twisted was the same as that for a one-layer outer sheath in which the outer sheath filaments were helically wound around the core and along a longitudinal direction of the core.

Note that the above filament diameter was measured using a micrometer.

### Test Example 1-1 to Test Example 1-9

For Test example 1-1 to Test example 1-9, length of lay was changed for each test example, and steel cords were formed such that lay length/filament diameter, which indicated a ratio of length of lay to a filament diameter, expressed a given value shown in Table 1, and then evaluation was performed.

Test example 1-2 to Test example 1-7 are examples; and Test example 1-1, Test example 1-8, and Test example 1-9 are comparison examples.

### Test Example 1-1

In Test example 1-1, a steel cord with a 2+7 construction, as illustrated in FIGS. 1 and 2, was formed. In this case, the number of core filaments was 2 and the number of outer sheath filaments was 7.

Four outer sheath filaments from among the outer sheath filaments were crimped filaments.

For each of the four crimped filaments, a percentage of a bend height relative to a filament diameter was 270%; and pitch in which bent sections and non-bent sections were repeatedly disposed was 6.3 mm.

The crimped filaments were placed every other filament, along the outer periphery of a given steel cord. In this case, in a cross-section of the steel cord 10 illustrated in FIG. 2, outer sheath filaments 12A, 12C, 12E, and 12G from among outer sheath filaments 12 were crimped filaments. Further, core filaments 11 and outer sheath filaments 12B, 12D, and 12F were filaments without having bent sections.

Additionally, the core filaments and the outer sheath filaments were twisted such that length of lay/filament diameter was 49, and a steel cord was thereby manufactured. Table 1 shows evaluated results.

### Test Example 1-2 to Test Example 1-9

A rotation speed at which a twisting machine operated was adjusted such that length of lay/filament diameter expressed a given value shown in Table 1. Each steel cord was formed in the same manner as in Test example 1-1, except that the steel cord was formed.

Table 1 shows evaluated results.

TABLE 1

| | | | DEGREE OF |
|---|---|---|---|
| | | | RUBBER |
| | LENGTH OF LAY/ | FLARE | PENETRATION |
| | FILAMENT DIAMETER | RATING | (%) |
| TEST | 49 | A | 75 |
| EXAMPLE | | | |
| 1-1 | | | |
| TEST | 50 | A | 70 |
| EXAMPLE | | | |
| 1-2 | | | |
| TEST | 59 | A | 70 |
| EXAMPLE | | | |
| 1-3 | | | |
| TEST | 65 | A | 65 |
| EXAMPLE | | | |
| 1-4 | | | |
| TEST | 68 | A | 66 |
| EXAMPLE | | | |
| 1-5 | | | |
| TEST | 70 | A | 62 |
| EXAMPLE | | | |
| 1-6 | | | |
| TEST | 73 | A | 61 |
| EXAMPLE | | | |
| 1-7 | | | |
| TEST | 76 | A | 58 |
| EXAMPLE | | | |
| 1-8 | | | |
| TEST | 79 | B | 52 |
| EXAMPLE | | | |
| 1-9 | | | |

From the results in Table 1, with respect to steel cords each of which had a two-layer stranded construction in which length of lay for a core was the same as that for an outer sheath, and in each of which core filaments and outer sheath filaments had the same filament diameters, it was confirmed that when length of lay/filament diameter was changed, the degree of rubber penetration was changed accordingly.

Further, it was confirmed that, with respect to given steel cords, when length of lay/filament diameter was 75 or less, the degrees of rubber penetration could be sufficiently increased to be 60% or more.

As described above, with respect to a steel cord that was conventionally considered to be unable to provide a sufficient degree of rubber penetration; in which length of lay for a core was the same as that for an outer sheath; and in each of which component filaments had the same filament diameters, it was confirmed that length of lay that was not conventionally considered was selected whereby sufficient degrees of rubber penetration were provided in practice.

However, if length of lay is excessively decreased, productivity may be decreased. In order to increase the productivity, it is preferable that length of lay/filament diameter be 50 or more.

### Test Example 2-1 to Test Example 2-7

For Test example 2-1 to Test example 2-7, steel cords were formed using crimped filaments for each of which a percentage of a bend height relative to a filament diameter was varied for each test example, and then evaluation was performed.

All of Test example 2-1 to Test example 2-7 are examples.

### Test Example 2-1

A steel cord was formed in the same manner as in Test example 1-2, except that, as crimped filaments, filaments for each of which a percentage of a bend height relative to a filament diameter was 255% were used.

In other words, a steel cord with a 2+7 construction, as illustrated in FIGS. 1 and 2, was formed. In a cross-section of the steel cord 10 illustrated in FIG. 2, four outer sheath filaments 12A, 12C, 12E, and 12G from among outer sheath filaments 12 were crimped filaments. Further, core filaments 11 and outer sheath filaments 12B, 12D, and 12F were filaments without having bent sections. Note that for each of the four crimped filaments, a percentage of a bend height relative to a filament diameter expressed the same value; and pitch in which bent sections and non-bent sections were repeatedly disposed was 6.3 mm.

Additionally, the core filaments and the outer sheath filaments were twisted such that length of lay/filament diameter was 50, and a steel cord was thereby manufactured. Table 2 shows evaluated results.

### Test Example 2-2 to Test Example 2-7

Each steel cord was formed in the same manner as in Test example 2-1, except that crimped filaments for each of which a percentage of a bend height relative to a filament diameter expressed a given value shown in Table 2 were used.

Note that in each Test example, in a cross-section of the steel cord 10 illustrated in FIG. 2, four outer sheath filaments 12A, 12C, 12E, and 12G were crimped filaments. With respect to the same steel cord, for each of the four crimped filaments, a percentage of a bend height relative to a filament diameter expressed the same value; and pitch in which bent sections and non-bent sections were repeatedly disposed was 6.3 mm.

Table 2 shows evaluated results.

TABLE 2

| | PERCENTAGE | | | |
|---|---|---|---|---|
| | OF | | | DEGREE |
| | BEND HEIGHT | NUMBER | | OF |
| | RELATIVE TO | OF | | RUBBER |
| | FILAMENT | CRIMPED | | PENE- |
| | DIAMETER | FILAMENTS | FLARE | TRATION |
| | (%) | (NUMBER) | RATING | (%) |
| TEST | 255 | 4 | A | 62 |
| EXAMPLE | | | | |
| 2-1 | | | | |
| TEST | 260 | 4 | A | 62 |
| EXAMPLE | | | | |
| 2-2 | | | | |
| TEST | 265 | 4 | A | 63 |
| EXAMPLE | | | | |
| 2-3 | | | | |
| TEST | 270 | 4 | A | 70 |
| EXAMPLE | | | | |
| 2-4 | | | | |
| TEST | 275 | 4 | A | 77 |
| EXAMPLE | | | | |
| 2-5 | | | | |
| TEST | 280 | 4 | A | 82 |
| EXAMPLE | | | | |
| 2-6 | | | | |
| TEST | 285 | 4 | B | 80 |
| EXAMPLE | | | | |
| 2-7 | | | | |

From the results in Table 2, with respect to steel cords each of which had a two-layer stranded construction, in which length of lay for a core was the same as that for an outer sheath, and in each of which used filaments had the same filament diameters, it was confirmed that, when a percentage of a bend height relative to a filament diameter of a given crimped filament from among filaments was changed, the degree of rubber penetration was changed accordingly.

It is considered that, this is because, in accordance with a percentage of a bend height relative to a filament diameter being changed, gaps between outer sheath filaments were varied, so that the degree of rubber penetration was thereby changed.

For all of Test example 2-1 to Test example 2-7, it was confirmed that sufficient degrees of rubber penetration were provided in practice. Particularly, in Test example 2-2 to Test example 2-6 using crimped filaments for each of which a percentage of a bend height relative to a filament diameter was between 260% and 280%, it was confirmed that the degrees of rubber penetration each exceeded 60%, and that flare generation could be also reliably suppressed. For this reason, with respect to each of used crimped filaments, it was confirmed that a percentage of a bend height relative to a filament diameter was more preferably between 260% and 280%.

### Test Example 3-1 to Test Example 3-5

For Test example 3-1 to Test example 3-5, steel cords were formed using crimped filaments for each of which a percentage of a bend height relative to a filament diameter was varied for each test example.

Evaluation was then performed.

All of Test example 3-1 to Test example 3-5 are examples;

### Test Example 3-1

A steel cord was formed in the same manner as in Test example 1-2, except that, as crimped filaments, filaments for each of which a percentage of a bend height to a filament diameter was 255% were used; and the number of crimped filaments was 6.

In other words, a steel cord with a 2+7 construction, as illustrated in FIGS. 1 and 2, was formed. In a cross-section of the steel cord 10 illustrated in FIG. 2, six outer sheath filaments 12A to 12F from among outer sheath filaments 12 were crimped filaments. Further, core filaments 11 and an outer sheath filament 12G were used as filaments without having bent sections. Note that for each of the six crimped filaments, a percentage of a bend height relative to a filament diameter expressed the same value; and pitch in which bent sections and non-bent sections were repeatedly disposed was 6.3 mm.

Additionally, the core filaments and the outer sheath filaments were twisted such that length of lay/filament diameter was 50, and a steel cord was thereby manufactured. Table 3 shows evaluated results.

### Test Example 3-2 to Test Example 3-5

Each steel cord was formed in the same manner as in Test example 3-1, except that crimped filaments for each of which a percentage of a bend height relative to a filament diameter expressed a given value shown in Table 3 were used.

Note that in each Test example, in a cross-section of the steel cord 10 illustrated in FIG. 2, outer sheath filaments 12A to 12F were crimped filaments. With respect to the same steel cord, for each of the six crimped filaments, a percentage of a bend height relative to a filament diameter expressed the same value; and pitch in which bent sections and non-bent sections were repeatedly disposed was 6.3 mm.

Table 3 shows evaluated results.

TABLE 3

| | PERCENTAGE | | | |
|---|---|---|---|---|
| | OF | | | DEGREE |
| | BEND HEIGHT | NUMBER | | OF |
| | RELATIVE TO | OF | | RUBBER |
| | FILAMENT | CRIMPED | | PENE- |
| | DIAMETER | FILAMENTS | FLARE | TRATION |
| | (%) | (NUMBER) | RATING | (%) |
| TEST | 255 | 6 | A | 60 |
| EXAMPLE | | | | |
| 3-1 | | | | |
| TEST | 260 | 6 | A | 67 |
| EXAMPLE | | | | |
| 3-2 | | | | |
| TEST | 275 | 6 | A | 82 |
| EXAMPLE | | | | |
| 3-3 | | | | |
| TEST | 280 | 6 | A | 82 |
| EXAMPLE | | | | |
| 3-4 | | | | |
| TEST | 285 | 6 | B | 78 |
| EXAMPLE | | | | |
| 3-5 | | | | |

From the results in Table 3, with respect to steel cords each of which had a two-layer stranded construction in which length of lay for a core was the same as that for an outer sheath; and in each of which used filaments had the same filament diameters, it was also confirmed that, when a percentage of a bend height relative to a filament diameter of a given crimped filament from among filaments was changed, the degree of rubber penetration was changed accordingly.

For all of Test example 3-1 to Test example 3-5, it was confirmed that sufficient degrees of rubber penetration were provided in practice. Particularly, in Test example 3-2 to Test example 3-4 using crimped filaments for each of which a percentage of a bend height relative to a filament diameter was between 260% and 280%, it was confirmed that the degrees of rubber penetration each exceeded 60%, which became particularly high, and that flare generation could be also reliably suppressed. For this reason, it was confirmed that a percentage of a bend height relative to a filament diameter was more preferably between 260% and 280%.

### Test Example 4-1 to Test Example 4-5

For Test example 4-1 to Test example 4-5, steel cords were formed using crimped filaments for each of which a percentage of a bend height relative to a filament diameter was varied for each test example.

Evaluation was then performed.

All of Test example 4-1 to Test example 4-5 were examples.

### Test Example 4-1

A steel cord was formed in the same manner as in Test example 1-2, except that, as crimped filaments, filaments for each of which a percentage of a bend height to a filament diameter was 255% were used; and the number of crimped filaments was 2.

In other words, a steel cord with a 2+7 construction, as illustrated in FIGS. 1 and 2, was formed. In a cross-section of the steel cord 10 illustrated in FIG. 2, two outer sheath filaments 12A and 12E from among outer sheath filaments 12 were crimped filaments. Further, core filaments 11 and outer sheath filaments 12B to 12D, 12F, and 12G were filaments without having bent sections. Note that for each of the two crimped filaments, a percentage of a bend height relative to a filament diameter expressed the same value; and pitch in which bent sections and non-bent sections were repeatedly disposed was 6.3 mm.

Additionally, the core filaments and the outer sheath filaments were twisted such that length of lay/filament diameter was 50, and a steel cord was thereby manufactured. Table 4 shows evaluated results.

### Test Example 4-2 to Test Example 4-5

Each steel cord was formed in the same manner as in Test example 4-1, except that crimped filaments for each of which a percentage of a bend height to a filament diameter expressed a given value shown in Table 4 were used.

Note that in each Test example, in a cross-section of the steel cord 10 illustrated in FIG. 2, outer sheath filaments 12A and 12E were crimped filaments. With respect to the same steel cord, for each of the two crimped filaments, a percentage of a bend height relative to a filament diameter expressed the same value; and pitch in which bent sections and non-bent sections were repeatedly disposed was 6.3 mm.

Table 4 shows evaluated results.

TABLE 4

| | PERCENTAGE | | | |
|---|---|---|---|---|
| | OF | | | DEGREE |
| | BEND HEIGHT | NUMBER | | OF |
| | RELATIVE TO | OF | | RUBBER |
| | FILAMENT | CRIMPED | | PENE- |
| | DIAMETER | FILAMENTS | FLARE | TRATION |
| | (%) | (NUMBER) | RATING | (%) |
| TEST | 255 | 2 | A | 60 |
| EXAMPLE | | | | |
| 4-1 | | | | |
| TEST | 260 | 2 | A | 62 |
| EXAMPLE | | | | |
| 4-2 | | | | |
| TEST | 270 | 2 | A | 62 |
| EXAMPLE | | | | |
| 4-3 | | | | |
| TEST | 280 | 2 | A | 65 |
| EXAMPLE | | | | |
| 4-4 | | | | |
| TEST | 285 | 2 | B | 77 |
| EXAMPLE | | | | |
| 4-5 | | | | |

From the results in Table 4, with respect to steel cords each of which had a two-layer stranded construction for each of which length of lay for a core was the same as that for an outer sheath; and in each of which used filaments had the same filament diameters, it was confirmed that, when a percentage of a bend height relative to a filament diameter of a given crimped filament from among filaments was changed, the degree of rubber penetration was changed accordingly. However, compared to Test example 2-1 to Test example 2-7, the change in the degree of rubber penetration in accordance with a percentage of a bend height to a filament diameter being changed was decreased. This is considered that, because the number of crimped filaments was only two, the change in a given percentage of a bend height relative to a filament diameter had little influence on the change in the degree of rubber penetration.

For all of Test example 4-1 to Test example 4-5, it was confirmed that sufficient degrees of rubber penetration were provided in practice. However, in Test example 4-2 to Test example 4-4 using crimped filaments for each of which a percentage of a bend height relative to a filament diameter was between 260% and 280%, it was confirmed that degrees of rubber penetration each exceeded 60%, which became particularly high, and that flare generation could be also reliably suppressed. For this reason, it was confirmed that a percentage of a bend height relative to a filament diameter was more preferably between 260% and 280%.

### Test Example 5-1 to Test Example 5-3

For Test example 5-1 to Test example 5-3, steel cords were formed, where the number of used crimped filaments was varied for each test example.

Evaluation was then performed.

All of Test example 5-1 to Test example 5-3 are examples.

### Test Example 5-1

A steel cord was formed in the same manner as in Test example 1-2, except that, as crimped filaments, filaments for each of which a percentage of a bend height relative to a filament diameter was 270% were used; and the number of crimped filaments was 2.

In other words, a steel cord with a 2+7 construction, as illustrated in FIGS. 1 and 2, was formed. In a cross-section of the steel cord 10 illustrated in FIG. 2, two outer sheath filaments 12A and 12E from among outer sheath filaments 12 were crimped filaments. Further, core filaments 11 and outer sheath filaments 12B to 12D, 12F, and 12G were filaments without having bent sections. Note that for each of the two crimped filaments, a percentage of a bend height relative to a filament diameter expressed the same value; and pitch in which bent sections and non-bent sections were repeatedly disposed was 6.3 mm.

Additionally, the core filaments and the outer sheath filaments were twisted such that length of lay/filament diameter was 50, and a steel cord was thereby manufactured. Table 5 shows evaluated results.

Note that the steel cord was the same as in Test example 4-3.

### Test Example 5-2

A steel cord was formed in the same manner as in Test example 1-2, except that, as crimped filaments, filaments for each of which a percentage of a bend height relative to a filament diameter was 270% were used; and the number of crimped filaments was 4.

In other words, a steel cord with a 2+7 construction, as illustrated in FIGS. 1 and 2, was formed. In a cross-section of the steel cord 10 illustrated in FIG. 2, four outer sheath filaments 12A, 12C, 12E, and 12G from among outer sheath filaments 12 were crimped filaments. Further, core filaments 11 and outer sheath filaments 12B, 12D, and 12F were filaments without having bent sections. Note that for each of the four crimped filaments, a percentage of a bend height relative to a filament diameter expressed the same value; and pitch in which bent sections and non-bent sections were repeatedly disposed was 6.3 mm.

Additionally, the core filaments and the outer sheath filaments were twisted such that length of lay/filament diameter was 50, and a steel cord was thereby manufactured. Table 5 shows evaluated results.

Note that the steel cord was the same as in Test example 2-4.

### Test Example 5-3

A steel cord was formed in the same manner as in Test example 1-2, except that, as crimped filaments, filaments for each of which a percentage of a bend height relative to a filament diameter was 270% were used; and the number of crimped filaments was 6.

In other words, a steel cord with a 2+7 construction, as illustrated in FIGS. 1 and 2, was formed. In a cross-section of the steel cord 10 illustrated in FIG. 2, six outer sheath filaments 12A to 12F from among outer sheath filaments 12 were crimped filaments. Further, core filaments 11 and an outer sheath filament 12G were filaments without having bent sections. Note that for each of the six crimped filaments, a percentage of a bend height relative to a filament diameter expressed the same value; and pitch in which bent sections and non-bent sections were repeatedly disposed was 6.3 mm.

Additionally, the core filaments and the outer sheath filaments were twisted such that length of lay/filament diameter was 50, and a steel cord was thereby manufactured. Table 5 shows evaluated results.

TABLE 5

| | PERCENTAGE | | | |
|---|---|---|---|---|
| | OF | | | DEGREE |
| | BEND HEIGHT | NUMBER | | OF |
| | RELATIVE TO | OF | | RUBBER |
| | FILAMENT | CRIMPED | | PENE- |
| | DIAMETER | FILAMENTS | FLARE | TRATION |
| | (%) | (NUMBER) | RATING | (%) |
| TEST | 270 | 2 | A | 62 |
| EXAMPLE | | | | |
| 5-1 | | | | |
| TEST | 270 | 4 | A | 70 |
| EXAMPLE | | | | |
| 5-2 | | | | |
| TEST | 270 | 6 | A | 81 |
| EXAMPLE | | | | |
| 5-3 | | | | |

From the results in Table 5, it was confirmed that when the number of used crimped filaments was changed, the degree of rubber penetration was changed accordingly. It is considered that, this is because, when the number of crimped filaments is increased, gaps between filaments are increased, so that rubber is easily penetrated.

It was confirmed that, in Test example 5-1 to Test example 5-3, the degrees of rubber penetration were sufficiently increased in practice, and that, in Test example 5-2 and Test example 5-3 in each of which the number of crimped filaments was 4 or more, the degrees of rubber penetration were particularly increased and flare generation could be also reliably suppressed.

According to the results in the present test examples, from the viewpoint of particularly increasing the degree of rubber penetration, it was confirmed that the number of outer sheath filaments preferably corresponded to 25% or more, and more preferably 50% or more. [Test example 6-1 to Test example 6-3] For Test example 6-1 to Test example 6-3, steel cords were formed, where the number of used crimped filaments was varied for each test example.

Evaluation was then performed.

All of Test example 6-1 to Test example 6-3 are examples.

### Test Example 6-1

A steel cord was formed in the same manner as in Test example 1-2, except that, as crimped filaments, filaments for each of which a percentage of a bend height relative to a filament diameter was 280% were used; and the number of crimped filaments was 2.

In other words, a steel cord with a 2+7 construction, as illustrated in FIGS. 1 and 2, was formed. In a cross-section of the steel cord 10 illustrated in FIG. 2, two outer sheath filaments 12A and 12E from among outer sheath filaments 12 were crimped filaments. Further, core filaments 11 and outer sheath filaments 12B to 12D, 12F, and 12G were filaments without having bent sections. Note that for each of the two crimped filaments, a percentage of a bend height relative to a filament diameter expressed the same value; and pitch in which bent sections and non-bent sections were repeatedly disposed was 6.3 mm.

Additionally, the core filaments and the outer sheath filaments were twisted such that length of lay/filament diameter was 50, and a steel cord was thereby manufactured. Table 6 shows evaluated results.

Note that the steel cord was the same as in Test example 4-4.

### Test Example 6-2

A steel cord was formed in the same manner as in Test example 1-2, except that, as crimped filaments, filaments for each of which a percentage of a bend height relative to a filament diameter was 280% were used.

In other words, a steel cord with a 2+7 construction, as illustrated in FIGS. 1 and 2, was formed. In a cross-section of the steel cord 10 illustrated in FIG. 2, four outer sheath filaments 12A, 12C, 12E, and 12G from among outer sheath filaments 12 were crimped filaments. Further, core filaments 11 and outer sheath filaments 12B, 12D, and 12F were filaments without having bent sections. Note that for each of the four crimped filaments, a percentage of a bend height relative to a filament diameter expressed the same value; and pitch in which bent sections and non-bent sections were repeatedly disposed was 6.3 mm.

Additionally, the core filaments and the outer sheath filaments were twisted such that length of lay/filament diameter was 50, and a steel cord was thereby manufactured. Table 6 shows evaluated results.

Note that it was the same steel cord as in Test example 2-6.

### Test Example 6-3

A steel cord was formed in the same manner as in Test example 1-2, except that, as crimped filaments, filaments for each of which a percentage of a bend height relative to a filament diameter was 280% were used; and the number of crimped filaments was 6.

In other words, a steel cord with a 2+7 construction, as illustrated in FIGS. 1 and 2, was formed. In a cross-section of the steel cord 10 illustrated in FIG. 2, six outer sheath filaments 12A to 12F from among outer sheath filaments 12 were crimped filaments. Further, core filaments 11 and an outer sheath filament 12G were filaments without having bent sections. Note that for each of the six crimped filaments, a percentage of a bend height relative to a filament diameter expressed the same value; and pitch in which bent sections and non-bent sections were repeatedly disposed was 6.3 mm.

Additionally, the core filaments and the outer sheath filaments were twisted such that length of lay/filament diameter was 50, and a steel cord was thereby manufactured. Table 6 shows evaluated results.

TABLE 6

| | PERCENTAGE | | | |
|---|---|---|---|---|
| | OF | | | DEGREE |
| | BEND HEIGHT | NUMBER | | OF |
| | RELATIVE TO | OF | | RUBBER |
| | FILAMENT | CRIMPED | | PENE- |
| | DIAMETER | FILAMENTS | FLARE | TRATION |
| | (%) | (NUMBER) | RATING | (%) |
| TEST | 280 | 2 | A | 65 |
| EXAMPLE | | | | |
| 6-1 | | | | |
| TEST | 280 | 4 | A | 82 |
| EXAMPLE | | | | |
| 6-2 | | | | |
| TEST | 280 | 6 | A | 82 |
| EXAMPLE | | | | |
| 6-3 | | | | |

From the results in Table 6, it was confirmed that when the number of used crimped filaments was changed, the degree of rubber penetration was changed accordingly. It is considered that, this is because, when the number of crimped filaments is increased, gaps between filaments are increased, so that rubber is easily penetrated.

It was confirmed that, in Test example 6-1 to Test example 6-3, the degrees of rubber penetration were sufficiently increased in practice, and that, in Test example 6-2 and Test example 6-3 in each of which the number of crimped filaments was 4 or more, the degrees of rubber penetration were particularly increased and flare generation could be also reliably suppressed.

From the results in the present test examples, from the viewpoint of particularly increasing the degree of rubber penetration, it was confirmed that the number of outer sheath filaments preferably corresponded to 25% or more, and more preferably 50% or more.

### REFERENCE SIGNS LIST

10, 20, 71 steel cord
11, 21 core filament
111, 211 core
12, 12A to 12G, 22 outer sheath filament
121, 221 outer sheath
13, 23 gap
40 crimped filament
41, 41A, 41B, 41C bent section
42 non-bent section
P pitch in which bent sections and non-bent sections are repeatedly disposed
h height of bent section
S plane
51 gear
52 filament
61 tire
62 tread
63 sidewall
64 bead
65 inner liner
66 carcass
67 belt layer
68 bead wire
72 rubber

1. A steel cord comprising;
a two-layer stranded construction including a core in which two or three core filaments are twisted, and including a one-layer outer sheath in which outer sheath filaments are helically wound around the core and along a longitudinal direction of the core,
wherein the core filaments have same filament diameters as the outer sheath filaments,
wherein length of lay for the core is same as length of lay for the outer sheath,
wherein length of lay/filament diameter, which indicates a ratio of length of lay to a filament diameter, is between 50 and 75, and
wherein two or more filaments selected from among the core filaments and the outer sheath filaments, are crimped filaments each including bent sections and non-bent sections that are repeatedly disposed along the longitudinal direction.

2. The steel cord according to claim 1, wherein when a height from a plane on which the crimped filaments are disposed, to a far bent section away from the plane, is defined as a bend height, the bend height of each crimped filament corresponds to between 260% and 280% of a filament diameter of the crimped filament.

3. The steel cord according to claim 1, wherein the outer sheath filaments include crimped filaments.

4. The steel cord according to claim 1, wherein a percentage of the crimped filaments relative to the outer sheath filaments is between 25% and 100%.

5. The steel cord according to claim 1, wherein the core filaments include only two core filaments.

6. The steel cord according to claim 1, wherein the core filaments include only two core filaments, and wherein the outer sheath filaments include only 6 to 8 outer sheath filaments.

7. The steel cord according to claim 1, wherein the core filaments includes only three core filaments, and wherein the outer sheath filaments include only 7 to 9 outer sheath filaments.

8. The steel cord according to claim 1, wherein the core filaments and the outer sheath filaments each have a filament diameter of from 0.30 mm to 0.42 mm.

9. A tire comprising the steel cord according to claim 1.

10. The steel cord according to claim 2, wherein the outer sheath filaments include crimped filaments.

11. The steel cord according to claim 2, wherein a percentage of the crimped filaments relative to the outer sheath filaments is between 25% and 100%.

12. The steel cord according to claim 3, wherein a percentage of the crimped filaments relative to the outer sheath filaments is between 25% and 100%.

13. The steel cord according to claim 2, wherein the core filaments include only two core filaments.

14. The steel cord according to claim 3, wherein the core filaments include only two core filaments.

15. The steel cord according to claim 4, wherein the core filaments include only two core filaments.

16. The steel cord according to claim 2, wherein the core filaments include only two core filaments, and wherein the outer sheath filaments include only 6 to 8 outer sheath filaments.

17. The steel cord according to claim 3, wherein the core filaments include only two core filaments, and wherein the outer sheath filaments include only 6 to 8 outer sheath filaments.

18. The steel cord according to claim 4, wherein the core filaments include only two core filaments, and wherein the outer sheath filaments include only 6 to 8 outer sheath filaments.

19. The steel cord according to claim 5, wherein the core filaments include only two core filaments, and wherein the outer sheath filaments include only 6 to 8 outer sheath filaments.

20. The steel cord according to claim 2, wherein the core filaments include only three core filaments, and wherein the outer sheath filaments include only 7 to 9 outer sheath filaments.
